(19) United States
(12) Patent Application Publication
(10) Pub. No.: US 2009/0197026 A1
(43) Pub. Date: Aug. 6, 2009

(54) Composition for treating glass-ceramic or glass to improve mechanical strength through curing of surface defects, treatment methods

(75) Inventors: Pablo Vilato, Aubervilliers (FR); Marie-Héléne Rouillon, Aubervilliers (FR); Caroline Faillat, Aubervilliers (FR); Sophie Besson, Aubervilliers (FR); Stéphane Lohou, Aubervilliers (FR); Olivier Gaume, Aubervilliers (FR); Didier Le Couviour, Aubervilliers (FR)

Correspondence Address: OBLON, SPIVAK, MCCLELLAND MAIER & NEUSTADT, P.C., 1940 DUKE STREET, ALEXANDRIA, VA, 22314, US

(73) Assignee: EUROKERA S.N.C., Chataeau-Thierry (FR)

(21) Appl. No.: 11/630,772

(22) PCT Filed: Jun. 15, 2005
(86) PCT No.: PCT/FR05/50445

§ 371 Date: Dec. 26, 2006

(30) Foreign Application Priority Data
Jul. 2, 2004 (FR) 0407359

(51) Int. Cl. B05D 3/00; C03C 17/32; D02G 3/00; B32B 17/10; C08J 3/28; C08F 2/50; C08F 20/26

(52) U.S. Cl. 428/34.7; 427/515; 427/140; 428/378; 428/431; 522/46; 522/84; 523/170

(57) ABSTRACT

This composition for treating the surface of a glass-ceramic, especially in plate form, flat glass or hollowware, or glass in the form of fibers, is able to be applied as a thin coating to said glass-ceramic or said glass. It comprises, in aqueous medium, the following constituents (A) and (B): (A) at least one compound having at least one functional group f_{(A)}; and (B) at least one compound having at least one functional group f_{(B)} capable of reacting with the functional group or groups f_{(A)} of constituent (A) within the thin coating applied to the glass-ceramic or the glass so as to convert said coating by polycondensation and/or curing into a solid coating, at least one of the compounds involved in the definition of (A) and (B) having at least one R—O-functional group attached to a silicon atom, R representing an alkyl residue, and at least some of the compounds having at least one R—O-functional group attached to a silicon atom, which may be in a hydrolyzed form resulting from a prehydrolysis or a spontaneous hydrolysis that has taken place while the compound or compounds are in contact with the aqueous medium.

The present invention relates to a composition for treating a glass-ceramic, especially in plate form, a glass, in particular flat glass or hollowware (bottles, flasks, etc.), or glass in the form of fibers, in order to improve the mechanical strength of said glass by healing surface defects thereon. The invention also relates to the corresponding treatment methods and to the glass thus treated.

International Application WO 98/45216 describes a method of manufacturing hollowware contain ers, having an impermeabilized surface whereby an aqueous-based treatment agent is applied to the containers leaving the annealing lehr downstream of the machine for manufacturing the hollowware containers, said treatment agent comprising:
(I) an aqueous-based composition containing organopolysiloxanes, which is prepared from an alkoxysilane carrying a functional group such as an amino, an alkylamino, a dialkylamino, an epoxy, etc. and from alkoxysilanes chosen from trialkoxysilanes, dialkoxysilanes and tetraalkoxysilanes; and
(II) a component containing no silicon, chosen from waxes, fatty acid partial esters and/or fatty acids and possibly containing a surfactant.

The surface temperature of the glass during application of the treatment agent rises to at least 30° C., being especially between 30 and 150° C. Through this treatment, the resistance to prolonged use of the containers is improved.

International Application WO 98/45217 describes the application of this coating agent as a second layer, the first layer being obtained from a treatment agent containing a trialkoxysilane and/or a dialkoxysilane and/or a tetraalkoxysilane or their hydrolysis and/or condensation products.

U.S. Pat. No. 6,403,175 B1 describes an agent for the cold treatment of hollowware containers for their surface reinforcement. This water-based agent contains at least the following components: a trialkoxysilane, a dialkoxysilane and/or a tetraalkoxysilane, their hydrolysis products and/or their condensation products; a water-soluble mixture of a polyol and a crosslinking agent for the polyol, the layer of cold treatment agent thus applied then being crosslinked over a temperature range between 100 and 350° C.

However, the filing company has endeavored to further improve the mechanical strength of glass-ceramic plates, glass, in particular flat glass or hollowware or glass in the form of fibers, and it has developed a novel coating composition that gives excellent results, said composition being an aqueous composition that can cure or polycondense on the surface of the glass to form a thin film that also reacts with the glass via SiOH or SiOR functional groups (R=alkyl).

The subject of the present invention is therefore a composition for treating the surface of a glass-ceramic, especially in plate form, or glass, in particular flat glass or hollowware, or glass in the form of fibers, said composition being able to be applied as a thin coating to said glass-ceramic or said glass, characterized in that it comprises, in aqueous medium, the following constituents (A) and (B):
(A) at least one compound having at 1 east one functional group f_{(A)}; and
(B) at least one compound having at least one functional group f_{(B)} capable of reacting with the functional group or groups f_{(A)} of constituent (A) within the thin coating applied to the glass-ceramic or the glass so as to convert said coating by polycondensation and/or curing into a solid coating; at least one of the compounds involved in the definition of (A) and (B) having at least one R—O-functional group attached to a silicon atom, R representing an alkyl residue; and
   at least some of the compounds having at least one R—O-functional group attached to a silicon atom, which may be in a hydrolyzed form resulting from a prehydrolysis or a spontaneous hydrolysis that has taken place while the compound or compounds are in contact with the aqueous medium.

The alkyl residue for R is especially a linear or branched C₁-C₈ alkyl residue.

The functional groups f_{(A)} and f_{(B)} may especially be chosen from —NH₂, —NH—, epoxy, vinyl, (meth)acrylate, isocyanate and alcohol functional groups.

In particular, the functional groups f_{(A)} and f_{(B)} of the constituents (A) and (B), respectively, may be chosen from the families indicated in the table below, with the thin coating being formed by UV-activated or thermally activated curing:

| | Method of forming the |
|---|---|
| Family | thin coating by curing |
| amine/epoxy | Heat |
| amine/(meth)acrylate | UV or heat |
| epoxy/(meth)acrylate | UV or heat |
| (meth)acrylate/(meth)acrylate | UV or heat |
| vinyl/(meth)acrylate | UV or heat |
| vinyl/vinyl | UV or heat |
| epoxy/epoxy | UV or heat |
| isocyanate/alcohol | Heat |

As regards the thermal method, it should be pointed out that this includes room-temperature curing, which may be possible in certain cases.

As examples of compounds falling within the definition of constituents (A) and (B), mention may be made of the following:
melamine, ethylenediamine and 2-(2-aminoethylamino)ethanol (compounds containing no SiOR or SiOH functional group);
derivatives of bisphenol A (compounds containing no SiOR or SiOH functional group);
(meth)acrylate monomers or oligomers (compounds containing no SiOR or SiOH functional group);
compounds of formula (I):

A-Si(R¹)ₓ(OR²)₃₋ₓ (I)

in which:
A is a hydrocarbon radical possessing at least one group chosen from the amino, alkylamino, dialkylamino, epoxy, acryloxy, methacryloxy, vinyl, aryl, cyano, isocyanato, ureido, thiocyanato, mercapto, sulfane or halogen groups, which is linked directly to the silicon or via an aliphatic or aromatic hydrocarbon residue;
R¹ represents an alkyl group, in particular C₁-C₃, or A as defined above;
R² represents a C₁-C₈ alkyl group that may be substituted with an alkyl [polyethylene glycol] residue;
x=0 or 1 or 2.

Mention may in particular be made of the following combinations (A)/(B):
methacryloxypropyltrimethoxysilane/polyethylene glycol diacrylate;
methacryloxypropyltrimethoxysilane/glycidoxypropylmethyldiethoxysilane; and
3-aminopropyltriethoxysilane/glycidoxypropylmethyldiethoxysilane.

According to one particular embodiment, the functional groups f_{(A)} of constituent (A) are —NH₂ and/or —NH-functional groups and the functional groups f_{(B)} of constituent (B) are epoxy functional groups, the ratio of the number of —NH-functional groups of constituent (A) to the number of epoxy functional groups is between 0.3/1 and 3/1, limits inclusive, especially between 0.5/1 and 1.5/1, limits inclusive.

Mention may be made of one particular composition according to the invention, which comprises 3-aminopropyltriethoxysilane as constituent (A) and glycidoxypropylmethyldiethoxysilane as constituent (B), but after being advantageously introduced in the prehydrolyzed state.

Once introduced into the aqueous medium, constituents (A) and (B), at least one of which includes at least one —SiOR functional group, undergo hydrolysis of the —SiOR functional group or groups into —SiOH over a relatively long time period after the contacting with water. In certain cases, an acid, such as hydrochloric acid or acetic acid, has to be added in order to catalyze the hydrolysis.

The condensation of the —SiOH functional groups into —SiO—Si— groups may even start at room temperature. Thus there may be (A)/(A), (A)/(B) and (B)/(B) reactions through the —SiOH functional groups, it being possible under certain conditions for these reactions to participate in the formation of a three-dimensional siloxane network. However, it will be advantageous to choose constituents (A) and (B) and also the operating conditions so that this network forms only very partly in aqueous solution.

According to the present invention, the composition is intended to be applied to the glass-ceramic or the glass to be treated and to form a thin coating by curing or polycondensation through the reaction of the functional groups f_{(A)} of constituent (A) with the functional groups f_{(B)} of constituent (B).

Moreover, the polycondensation product reacts with the glass-ceramic or the glass via SiOH and SiOR radicals, thus making it possible to heal the surface defects thereon, namely checks, cracks, shocks, etc. The film thus formed is intended to improve the mechanical strength of the glass-ceramic or the glass.

The composition according to the invention may furthermore include:
(C1) at least one polymerization or polycondensation catalyst for constituents (A) and (B); and/or
(C2) at least one UV or thermal radical polymerization initiator or UV cationic polymerization initiator,
   depending on the method used to form the hard coating.

Advantageously, constituent (C1) is or contains a tertiary amine, such as triethanolamine and diethanolamine propanediol. As examples of tertiary amines, mention may be made in general of those of formula (III):

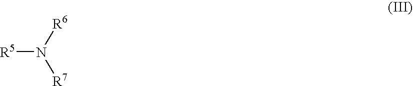

in which R⁵ to R⁷ each represent independently, an alkyl or hydroxyalkyl group. The presence of at lea st one catalyst helps to reduce the cure time and the cure temperature, thereby dispensing, in the case of coatings on bottles or the like, with the use of an additional curing oven and making it possible to work at a temperature of the bottles leaving the annealing lehr (for example at 150° C.), as will be described below.

The radical polymerization initiators (C2) are, for example, mixtures that include benzophenone, such as Irgacure® 500 sold by Ciba Specialty Chemicals.

The composition of the invention may furthermore include:
(D) at least one scratch/wear protection agent chosen from waxes, fatty acid partial esters and fatty acids, and polyurethanes and other polymers known for their protective function, such as acrylic polymers; and/or
(E) at least one polymer in emulsion, the T_{g} of which is between 0 and 100° C., in particular between 10 and 80° C.; and/or
(F) at least one surfactant, such as an anionic or nonionic surfactant.

As examples of waxes, mention may be made of polyethylene waxes, whether oxidized or not.

The waxes, fatty acid partial esters and fatty acids may be introduced into the composition in the state associated with a surfactant.

The protection agents (D) are thermoplastics and possess elastic slip properties. Their inclusion into the thin film formed contributes to scratch/wear protection during use and handling.

The polymers in emulsion (E) are in particular chosen from acrylic copolymers in emulsion, such as those of the HYCAR® series sold by Noveon.

As examples of surfactant (F), mention may be made of polyoxyethylene fatty ethers, such as C₁₈H₃₅(OCH₂CH₂)₁₀OH, known by the name Brij®97, and also polyethylene oxide/polypropylene oxide/polyethylene oxide triblock copolymers. Mention may also be made of the surfactants used in the examples below.

The composition according to the invention may thus comprise, in aqueous medium, for a total of 100 parts by weight:
up to 25 parts by weight of constituent (A);
up to 25 parts by weight of constituent (B);
0 to 25 parts by weight of constituent (C1) as defined above;
0 to 25 parts by weight of constituent (C2) as defined above;
0 to 25 parts by weight of constituent (D) as defined above;
0 to 25 parts by weight of constituent (E) as defined above; and
0 to 25 parts by weigh t of constituent (F) as defined above,
   the aforementioned quantities being indicated as dry matter and, when an agent is introduced in the form of an aqueous solution or emulsion, the quantity of water of this solution or emulsion then forming part of the aqueous medium of the composition.

The composition according to the invention advantageously has a viscosity at room temperature of between 1 and 3 centipoise according to the rotating cylinder method (Brookfield Rheovisco LV viscometer; speed=60 rpm; low-viscosity accessory).

The subject of the present invention is also a method of treating the glass-ceramic or glass surface in order to improve the mechanical strength thereof by healing the surface defects, characterized in that a thin film of the composition as defined in one of claims 1 to 15 is applied to the glass-ceramic or glass parts to be treated with a thickness that may range up to 3 microns, and in that said composition undergoes a curing or polycondensation reaction.

The composition according to the invention may be prepared with a view to its application by mixing its constituents, generally at the time of use, in various ways.

When the composition according to the invention contains the constituents (A)+(B)+water, it may be prepared by firstly mixing (A) with (B) and then by combining this mixture with water at the time of use.

It is also possible to prehydrolyze (A) and/or (B).

When catalysts and/or additives are present, they may be mixed with the water before (A) is mixed with (B) at the time of use.

It is also possible, if one of the constituents, (A) or (B), undergoes hydrolysis, to incorporate the additives into the nonhydrolyzed constituent.

Advantageously, the composition is applied by spraying or dip coating.

To form the thin hard coating, the applied coating may undergo a drying operation, for example for a few seconds, followed by passage beneath UV lamps, the UV treatment lasting for example, a few seconds to 30 seconds.

The heat curing or polycondensation may be carried out at a temperature of, for example, 100 to 200° C. for 5 to 20 minutes. However, the temperature and the duration of the treatment depend on the system used. Thus, there may be systems that allow the thin hard coating to form thermally at room temperature almost instantly.

If an article of hollowware is to be coated, the procedure may be to deposit the composition by spraying it onto the hollowware after the annealing lehr, the temperature of the hollowware during spraying being between 10 and 150° C.; and
when the composition does not contain a catalyst, by making the hollowware pass through a curing oven at a temperature of 100 to 220° C. for a period of time ranging from a few seconds to 10 minutes; and
when the composition does contain a catalyst, by letting the curing reaction take place without passage through a curing oven.

The present invention also relates to a glass-ceramic, flat glass or to hollowware treated by a composition as defined above, according to the method as defined above, and to glass fibers, especially optical fibers (for example those used for dentists' lamps) which are treated by a composition as defined above using the method as defined above.

The present invention also relates to the use of a composition as defined above, in order to improve the mechanical strength of the glass-ceramic or the glass by healing its surface defects.

The following examples illustrate the present invention without, however, limiting its scope. In these examples, the parts and percentages are by weight unless otherwise indicated.

In these examples:
SR610 is a 600 polyethylene glycol diacrylate sold by Cray Valley;
the compound CRAY VALLEY is a compound containing 67% SR610 as defined above and 33% of an aliphatic diacrylate oligomer sold under the name CN132 by Cray Valley. Since CN132 is scarcely miscible in water, it is necessary to predissolve it in the SR610;
the wax GK6006 is a polyethylene wax having a 25% solids content, sold by Morells;
the wax OG25 is a polyethylene wax with a 25% solids content, sold by Trub Emulsion Chemie AG; and
IRGACURE® 500 is the brand name of a radical polymerization initiator sold by Ciba-Geigy, containing 50% benzophenone and 50% 1-hydroxycyclohexylphenyl ketone.

### EXAMPLE 1a

### Flat Glass Provided with a Coating Film Formed by Drying Followed by UV Crosslinking

(a) Preparation of the Coating Composition

The following formulation was used, the quantities being given in parts by weight:

| | |
|---|---|
| Methacryloxypropyltrimethoxysilane | 1.5 |
| SR610 600 polyethylene glycol | 0.5 |
| diacrylate | |
| GK6006 wax | 1.5 |
| Surfactant from the family of | 0.1 |
| modified polysiloxanes, sold by | |
| Byk under the name BYK 341 | |
| IRGACURE 500 | 0.15 |
| Water | balance to 100 |

A coating composition for glass was prepared by hydrolyzing the silane of the formulation in water for 24 hours and then by adding the other constituents of the formulation.

(b) Formation of the Coating Film on Indented Flat Glass Plates

The composition thus obtained was deposited on a batch of 10 flat glass plates (dimensions 70×70×3.8 mm) on which defects were created by a Vickers indenter with a diamond pyramidal tip and an applied force of 50 N.

The coating was deposited by dip coating at a controlled rate of 500 mm/min in order to ensure a uniform thickness. This coating operation was carried out 24 hours after the indentation, so as to stabilize the crack propagation and to relax the stresses around the defect created.

The glass plates were then dried for 10 minutes at 100° C. and then the film applied as a coating underwent UV curing for 25 seconds, the characteristics of the UV emitter being the following:
distance of the substrate surface from the lamp: 5 cm;
iron-doped mercury lamp (type F Strahler UVH lamp);
power: 150 W/cm.

(c) Fracture Test in Three-Point Bending

The fracture test in three-point bending was carried out on the glass plates thus coated, by putting the defect created into extension. This test was performed without UV aging and environmental aging of the coatings formed.

A batch of 10 uncoated flat glass plates served as control.

The three-point fracture results are expressed as the modulus of rupture (MOR) in MPa and are used to evaluate the reinforcing performance of the composition. The reinforcement results for the coating are expressed as the difference between the modulus of rupture in the bending test for the control flat glass plates and the modulus of rupture of the treated flat glass plates.

The results are given in Table 1 below.

TABLE 1

| | | Glass treated by the |
|---|---|---|
| | Control | formulation of this |
| | (uncoated) | example |
| Mean fracture stress | 38.9 | 80.9 |
| (MPa) | | |
| Standard deviation | 2.9 | 20 |
| (MPa) | | |
| Reinforcement | | 107.8% |

The formulation of this example shows a very pronounced reinforcement effect of the weakened glass plates, this reinforcement being in fact 107.8% compared with indented flat glass plates with no coating.

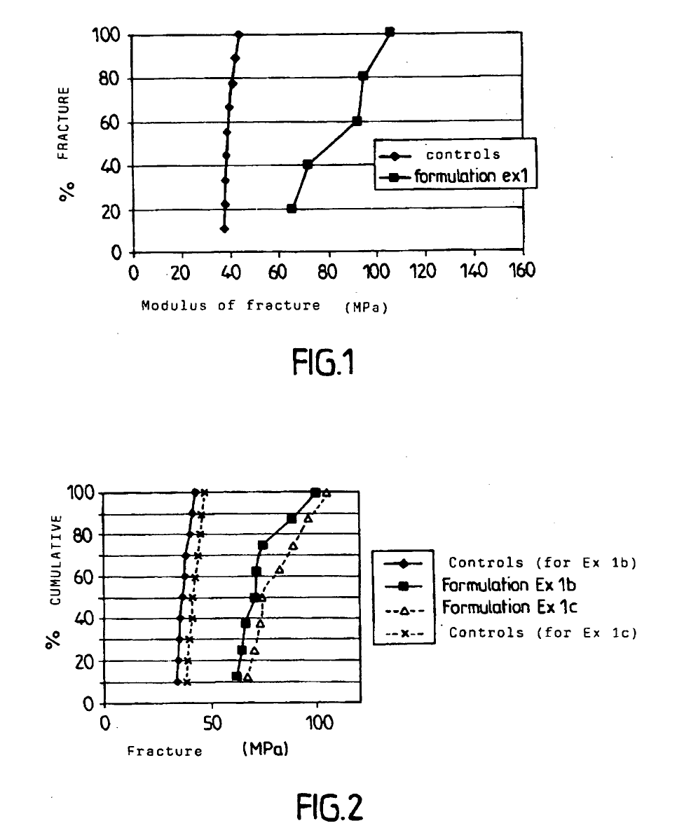

The graph in FIG. 1 shows the cumulative fracture as a percentage plotted as a function of the modulus of rupture in MPa. The curve showing the 10 coated flat glass specimens is shifted towards higher modulae of rupture compared with the curve for the 10 flat glass specimens with no coating.

The coating formed from the composition of this example therefore gives the glass greater mechanical strength.

### EXAMPLES 1b and 1c

### Flat Glass Plates with a Coating Film Formed by Drying Followed by UV Crosslinking

The following formulations were used, the quantities being given in parts by weight.

### EXAMPLE 1b

| | |
|---|---|
| Aminopropyltriethoxysilane | 1 |
| CRAY VALLEY compound | 10 |
| Sodium dodecylsulfate (surfactant) | 0.3 |
| IRGACURE 500 | 0.25 |
| Water | balance to 100 |

### EXAMPLE 1c

| | |
|---|---|
| Methacryloxypropyltrimethoxysilane | 1 |
| CRAY VALLEY compound | 10 |
| Acrylated surfactants sold by Byk under | 1 |
| the name BYK 3500 UV | |
| Copolymeric surfactant sold under the | 0.2 |
| name GANTREZ | |
| Sodium dodecylsulfate (surfactant) | 0.5 |
| Water | balance to 100 |

For each of the formulations of Examples 1b and 1c, the procedure was as in Example 1a except that the crosslinking time was around 20 seconds.

The results are expressed by the graph in FIG. 2 of the appended drawing. Each treatment has to be compared with its respective control. The two formulations appear to give reinforcements of around 100%.

### EXAMPLE 2

### Flat Glass Plates Provided with a Coating Film Formed by Heat Curing

(a) Preparation of the Coating Composition

The following formulation was used, the quantities being given in parts by weight:

| | |
|---|---|
| Methacryloxypropyltrimethoxysilane | 1 |
| Glycidoxypropylmethyldiethoxysilane | 1 |
| GK6006 wax | 1.5 |
| Water | balance to 100 |

A coating composition for glass was prepared by the following operating method.

The two silanes were premixed for 5 minutes and then water was added and the silanes were hydrolyzed with vigorous stirring for 30 minutes. The wax was then added.

(b) Formation of the Coating Film on Indented Flat Glass Plates

The procedure was then as in Example 1b, except that instead of the drying followed by UV curing, a heat treatment was carried out for 25 minutes at 240° C.

(c) Fracture Test in Three-Point Bending

The same test as in Example 1c was carried out on the glass plates thus coated.

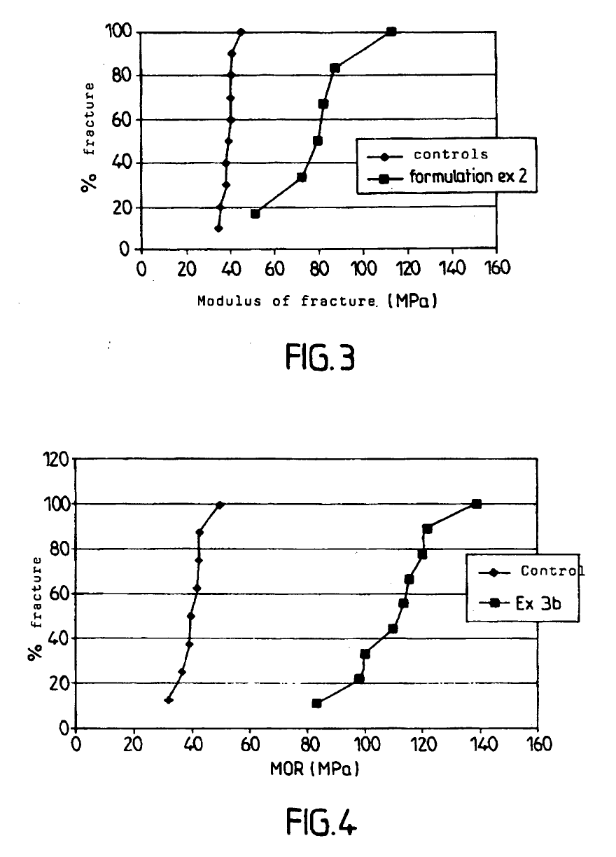

The results obtained are given in Table 2 below and in FIG. 3.

TABLE 2

| | | Glass treated by the |
|---|---|---|
| | Control | formulation of this |
| | (uncoated) | example |
| Mean fracture stress | 39.7 | 86.4 |
| (MPa) | | |
| Standard deviation | 2.3 | 16.7 |
| (MPa) | | |
| Reinforcement | | 117.8% |

### EXAMPLES 3a to 3d

### Flat Glass Plates Provided with a Coating Film Formed by Heat Curing

(a) Preparation of the Coating Compositions

The following compositions were used, the quantities being given in parts by weight:

| | Example | | | |
|---|---|---|---|---|
| | 3a | 3b | 3c | 3d |
| 3-Aminopropyltriethoxysilane | 0.5 | 1 | 0.3 | 0.5 |
| Glycidoxypropylmethyldiethoxysilane | 1 | 2 | 1 | 1 |
| OG25 wax | 1.5 | 1.5 | 1.5 | |
| GK6006 wax | | | | 1.5 |
| Polyurethane of 25% solids content, | 1.5 | 1.5 | 1.5 | 1.5 |
| sold by Diegel under the name | | | | |
| BG49300 | | | | |
| Deionized water, balance to | 100 | 100 | 100 | 100 |

On the one hand, a first drum containing the aminopropyltriethoxysilane and the glycidoxypropylmethyldiethoxysilane was prepared by mixing them for 5 to 7 minutes (Example 3a) and for 10 minutes (Examples 3b, 3c and 3d) and, on the other hand, a second drum, containing the polyethylene wax, the polyurethane and the water was prepared, and then the contents of the two drums were mixed together for 30 minutes before application.

(b) Formation of the Coating Layer on Indented Flat Glass Plates

The procedure was then as in Example 2b, except that the heat treatment (curing) was carried out at 200° C. for 20 minutes.

(c) Fracture Test in Three-Point Bending

The same test as in Example 1c was carried out on the glass plates thus coated with the composition of Example 3b.

The results are given in Table 3 below and in FIG. 4.

TABLE 3

Coating on 50 N
indentation

| | | Glass treated by the |
|---|---|---|
| | Control | formulation of |
| | glass | Example 3b |
| Mean fracture stress | 40.1 | 111.2 |
| (MPa) | | |
| Standard deviation | 5.2 | 16.1 |
| (MPa) | | |
| Reinforcement | | 177.3 |

In the graph of FIG. 4, the curve showing the ten coated flat glass specimens is shifted toward higher modulus of rupture values compared with the curve for the ten flat glass specimens with no coating.

The coating formed from the composition of Example 3b therefore gives the glass greater mechanical strength.

(d) Three-Point Bending Test on Indented Flat Glass Plates with UV and Environmental Aging of the Coating Formed from the Composition of Example 3b

Two aging tests were used, namely the WOM (Weather —O-Meter) test, in which the flat glass specimens underwent LW exposure for 540 h, and the VE (Variable Environment) test, in which the flat glass specimens underwent −10° C./+90° C. cycles for 15 days, one cycle lasting 8 h at 95% RH.

The results are given in FIG. 5 and in Table 4 below:

TABLE 4

| | Reinforcement | | |
|---|---|---|---|
| | (%) | | |
| | No aging | After WOM | After VE |
| Based on the | 161% | 161% | 160% |
| composition | | | |
| of Example 3b | | | |

The reinforcement provided by the coating based on the composition of Example 3b is unmodified after the WOM and VE aging tests.

(e) Observation with the Naked Eye of the Appearance of the Coating Based on the Composition of Example 3b (after WOM and VE)

The glass having the coating based on the composition of Example 3b did not suffer any degradation after 540 hours of UV exposure. It was not impaired by the humidity under the conditions of the VE test described above.

### EXAMPLES 4a and 4b

### Preparation of Compositions According to the Invention with Prehydrolysis of at Least One Silane

A composition was prepared as in Example 3a except that both silanes were prehydrolyzed (in Example 4a) and the glycidoxypropylmethyldiethoxysilane was prehydrolyzed (in Example 4b) with all the water for 15 minutes.

### EXAMPLES 5a and 5b

### Preparation of Compositions According to the Invention with the Introduction of Catalysts

A composition was prepared as in Example 3a except that 0.15 parts of triethanolamine were added to the second drum (Example 5a).

A composition was prepared as in Example 3c, except that 0.075 parts of triethanolamine and 0.075 parts of diethanolamine propanediol were added to the second drum (Example 5b).

### EXAMPLE 6

### Influence of the Glycidoxypropylmethyldiethoxysilane Prehydrolysis

The FTIR spectrograms of the formulation of Example 3a with simultaneous hydrolysis at 23° C. of both silanes are identical with and without prehydrolysis of the glycidoxypropylmethyldiethoxysilane after 23 minutes of mixing.

After 23 minutes, the hydrolysis of the 3-aminopropyltriethoxysilane and the glycidoxypropylmethyldiethoxysilane is completed. The prehydrolysis of the glycidoxypropylmethyldiethoxysilane does not affect the hydrolysis reaction rate of the two silanes. However, the prehydrolysis of the glycidoxypropylmethyldiethoxysilane does have an influence on the reinforcement over time.

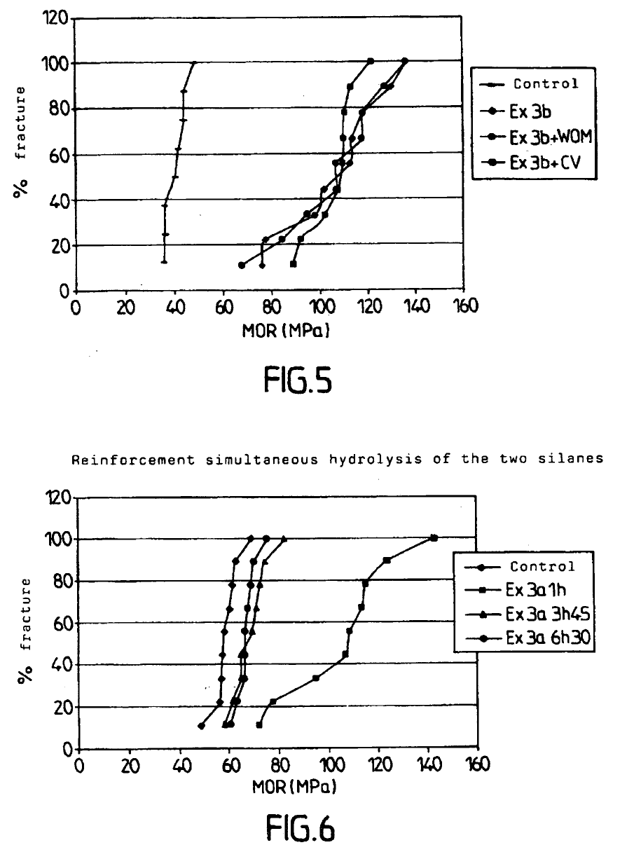

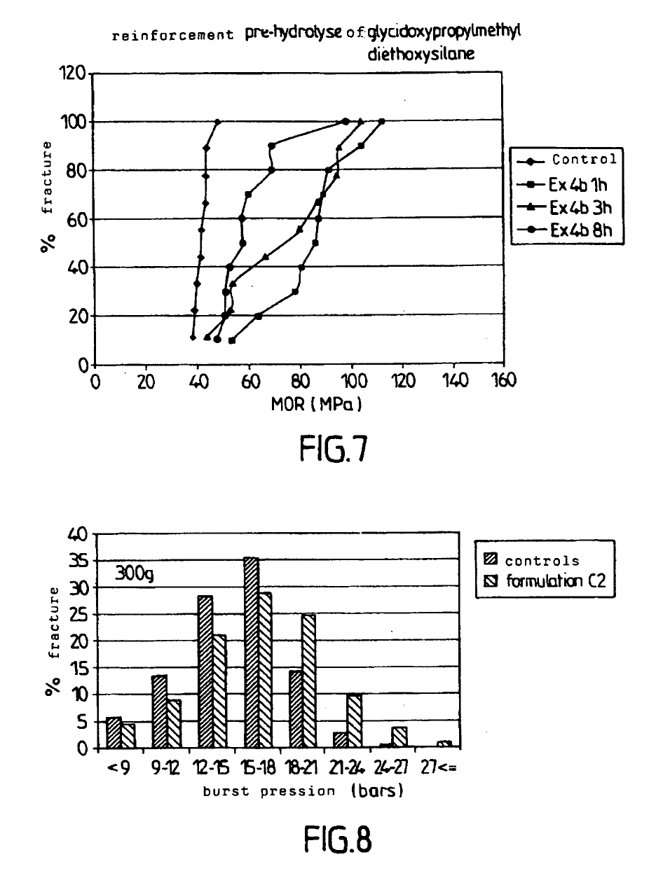

The reinforcement results on flat glass plates as a function of maturation time (1 h, 3 h and 6 h or 8 h) for the formulations of Examples 3a and 4b are illustrated in FIGS. 6 and 7 respectively.

TABLE 5
Table summarizing the reinforcements with the
formulations of Examples 3a and 4b in the three -point
bending test on flat glass plates indented with 50 N

| | Percentage | | | | |
|---|---|---|---|---|---|
| | reinforcement for | | | | |
| | various maturation | | | | |
| | times: | | | | |
| | | | 3 h | 6 h | |
| | 1 h | 3 h | 45 | 30 | 8 h |
| with the formulation | 80% | — | 17% | 14% | — |
| of Example 3a: | σ = | | σ = | σ = | |
| simultaneous | 22.2 | | 7.4 | 4.3 | |
| hydrolysis of both | | | | | |
| silanes | | | | | |
| with the formulation | 101% | 79% | — | — | 46% |
| of Example 4b: | σ = | σ = | | | σ = |
| prehydrolysis of the | 17.4 | 22 | | | 15 |
| glycidoxypropylmethyl | | | | | |
| diethoxysilane | | | | | |

σ = standard deviation.

The reinforcement on the flat glass specimens indented with 50 N degrades over the course of time. After a 3 hour life time of the compound, the reinforcement both without glycidoxypropylmethyldiethoxysilane prehydrolysis (=simultaneous hydrolysis) and with glycidoxypropylmethyldiethoxysilane prehydrolysis drops. However, prehydrolysis seems to moderate this reduction in the reinforcement properties: it remains at 46% after 8 hours of aging of the formulation, whereas the reinforcement with the formulation of Example 3a (without prior prehydrolysis of the glycidoxypropylmethyldiethoxysilane) is then only 14% after 6 h 30 of maturation of the compound.

One recommended operating method therefore consists in firstly hydrolyzing the glycidoxypropylmethyldiethoxysilane for a few minutes (5 to 10 minutes) in order to achieve a level of reinforcement that is stable and durable.

### EXAMPLE 7

### Variation in the Viscosity

The viscosity of the formulation of Examples 3 and 4 with and without prehydrolysis of the glycidoxypropylmethyldiethoxysilane is dependent on the temperature at which the compound is mixed (20° C. or 40° C.). The viscosity changes more rapidly the higher the temperature. The viscosity of the formulation is also dependent on the nature of the polyethylene wax (OG25 or GK6006) used. When GK6006 is used (Example 3d), the compound seems to be stable over the course of time, whereas when the formulation contains OG25 an increase in viscosity is observed.

### EXAMPLE 8

### Optimization of the Curing (Time and Temperature) with Tertiary Amine Catalysts

The use of a triethylamine tertiary amine shortens the cure time by half (10 minutes as opposed to 20 minutes) and lowers the cure temperature by 50° C. (150° C. as opposed to 200° C.), while still maintaining a level of reinforcement of about 90%.

A more economic use of the curing oven, which is installed in line downstream of the cold end, can be achieved by optimizing the formulation so that it consumes less energy.

Table 6 below is a table summarizing the results obtained.

TABLE 6

| | | Formulation of: | | | |
|---|---|---|---|---|---|
| | | Ex 3b | Ex 4a | | Ex 4b |
| Coating on 50 | | 200° C., | 200° C., | 150° C., | 150° C., |
| N indentation | Control | 20 min | 20 min | 20 min | 20 min |
| Mean (MPa) | 41.5 | 107 | 75 | 59 | 75 |
| Standard | 4.3 | 21 | 8 | 18 | 16 |
| deviation | | | | | |
| (MPa) | | | | | |
| Reinforcement | | 161 | 112 | 66 | 90 |
| (%) | | | | | |

### EXAMPLE 9

### Mechanical Reinforcement of the Edges of Window Panes. Tests on Flat Glass Plates for Automobile and Building Applications

Defects along the edges are less severe than defects created with a 50 N indenter. The cutting and the shaping of the glass creates smaller defects along the edges. To simulate the small edge defects, a force of 5 N is applied during the indentation. The size (indentation with 50 N or 5 N) and the nature of the defect (indentation or shaping) lead to different levels of reinforcement for the coating of Example 3a.

This is because the reinforcement of the edges after coating the flat glass plates and after the 4-point bending test is 17.1%, whereas for an indentation with 5 N or 50 N values of 55.3 and 177.3% are obtained, respectively.

Table 7 below is a table summarizing the results obtained.

TABLE 7

| | | Formulation |
|---|---|---|
| | | of Example |
| | Control | 3a |
| Reinforcement of the edges | | |
| in 4-point bending | | |
| Mean (MPa) | 83.2 | 97.4 |
| Standard deviation (MPa) | 7.1 | 4.7 |
| Reinforcement (%) | | 17.1 |
| Three-point bending: | | |
| Coating on 50 N | | |
| indentation | | |
| Mean (MPa) | 40.1 | 111.2 |
| Standard deviation (MPa) | 5.2 | 16.1 |
| Reinforcement (%) | | 177.3 |
| Three-point bending: | | |
| Coating on 5 N indentation | | |
| Mean (MPa) | 81.8 | 127.0 |
| Standard deviation (MPa) | 5.9 | 21.4 |
| Reinforcement (%) | | 55.3 |

### EXAMPLES 10a and 10b

### Mechanical Reinforcement Obtained on Bottles

The following formulations were used:

Formulation of Example:

| | 10a | 10b |
|---|---|---|
| Aminopropyltriethoxysilane | 0.3 | 0.3 |
| Glycidoxypropyltriethoxysilane | 1 | 1 |
| GK6006 wax | 1.5 | 0.4 |
| Water, balance to: | 100 | 100 |

The glass coating compositions were prepared by the following operating method.

The epoxysilane was hydrolyzed for 10 minutes in water and then the aminosilane was added and hydrolyzed for 20 minutes before the GK6006 wax was added.

The test was carried out on a bottle production line using a 16-section, 32-mold IS machine for 300 and 410 g burgundy bottles.

The bottles were taken as they left the lehr before the cold treatment and were then treated by spraying them cold under the following conditions: bottles top down on spinners, two nozzles for treating the bottom and sides of the bottles, respectively. The spray nozzles specifically for the sides was 16 cm from the bottle and its spray axis was located at 11 cm from the bottom of this same bottle. The nozzle for the bottom was located at 16 cm from the bottle and it sprayed the sides within 3 cm of the bottom.

The rotation speed of the spinner was 120 rpm and the spray times were chosen so as to make complete revolutions. The atomization air pressure was 5.5 bar.

The parameters were set so as to obtain a spray angle of about 8° with the formulation of Example 11a:
sides nozzle: 4 liters/h;
bottom nozzle: 4 liters/h;
spray time: 2 seconds.

Some of the bottles removed were treated by spraying (on cold bottles), dried for 15 minutes and then heat treated in an oven for 20 minutes at 200° C. The other bottles served as control. Each series consisted of 320 bottles (10 bottles per mold). The entire surface of the bottles was treated and also the bottom. The thickness of the coating was 150 to 300 nm.

The bottles treated with the formulation of Example 10a had a spray angle of 8° while those treated with the formulation of Example lob had a spray angle of 20°.

The strength of the bottles was evaluated in an internal pressure test (AGR machine). The burst histograms are given in FIGS. 8 and 9 and the mean burst pressures are given in Table 8 below.

TABLE 8

| | 300 g | | 410 g | | |
|---|---|---|---|---|---|
| | | Formulation: | | Formulation: | Formulation |
| | Control | Ex. 10b | Control | Ex. 10a | Ex. 10b |
| Mean burst | 14.9 ± 0.4 | 16.6 ± 0.5 | 22.6 ± 0.8 | 27.3 ± 1.1 | 27.4 ± 1.10 |
| pressure | | | | | |
| Standard | 3.5 | 4.2 | 7.7 | 9.4 | 9.2 |
| deviation | | | | | |
| % < 12 bar | 19.5 | 14.5 | 6.0 | 1.6 | 2.8 |
| % < 15 bar | 49.1 | 34.4 | 19.4 | 12.3 | 11.2 |

### EXAMPLE 11

### Addition of a Polymer in Emulsion to the Composition; Coating Formed by Heat Curing

(a) Preparation of the Coating Composition

The following formulation was used, the quantities being given in parts by weight:

| | |
|---|---|
| Glycidoxypropylmethyldiethoxysilane | 1.0 |
| 3-Aminopropyltriethoxysilane | 0.3 |
| Emulsion of a copolymer having a T_{g} of | 2.6 |
| 36° C., sold by Noveon under the brand name | |
| Hycar ® 26391 | |
| Water | balance to 100 |

To prepare the coating composition, the epoxysilane was dissolved in water for 5 minutes. Then the aminosilane was added and mixed for 15 minutes. Finally, the copolymer emulsion was added and mixed for 3 minutes.

The same formulation but without the emulsion was also prepared.

(b) Deposition of the Coating on Indented Flat Glass Plates

The coating compositions thus prepared were deposited on glass specimens indented with 10 N by dipping these glass plates into said compositions at a rate of 50 cm/min, followed by drying the specimens in air for 10 minutes and then heat treating them at 200° C. for 20 minutes.

(c) Fracture Test in Three-Point Bending

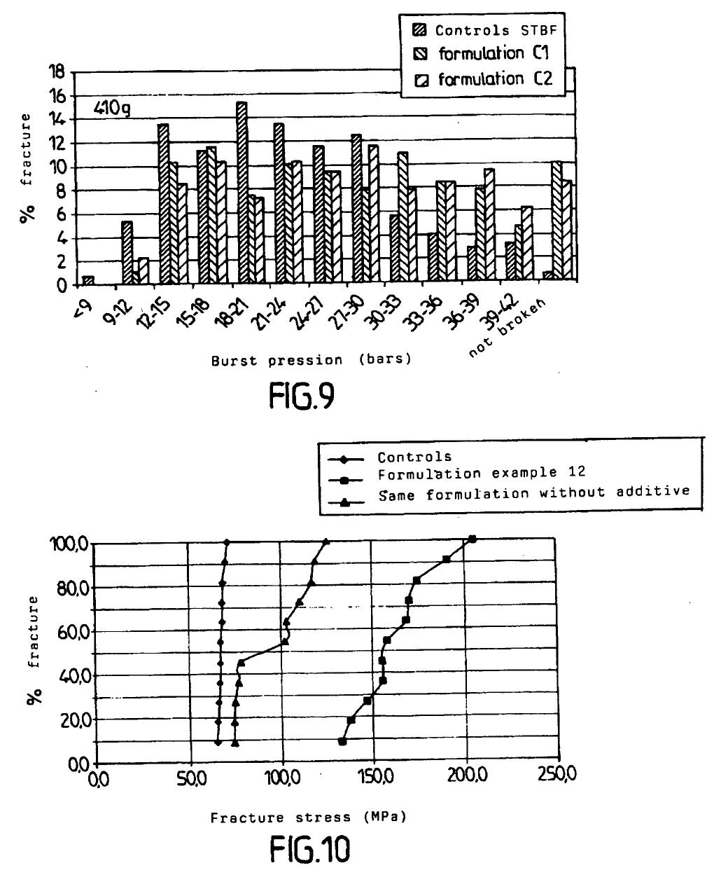

The procedure was as in Example 1a, section (c), the results obtained being given in Table 9 below and in FIG. 10.

TABLE 9

| | | | Same |
|---|---|---|---|
| | | Formulation | formulation |
| | Control (not | of Example | with no |
| | coated) | 11 | emulsion |
| Mean rupture | 68 | 157 | 95 |
| stress (MPa) | | | |
| Standard | 2.1 | 17.9 | 19.4 |
| deviation | | | |
| (Mpa) | | | |
| Reinforcement | — | 131 | 40 |
| (%) | | | |

### EXAMPLE 12

### Mechanical Reinforcement of Glass-Ceramic Cooking Ranges (Hobs)

A composition not varying from that of Example 10a except by a GK6006 wax content of 2% instead of 1.5% was sprayed onto a KERABLACK (registered trade mark of Eurokera) glass-ceramic plate.

Once again, the epoxy silane was hydrolyzed for 10 minutes in water and then the aminosilane was added and hydrolyzed for 20 minutes before the GK6006 wax was added.

The plates tested were “smooth-smooth”, i.e. both sides being smooth (as opposed to plates mechanically reinforced by forming studs or reliefs on one or both sides, by calendering between rolls having the complementary reliefs). Their dimensions were 300 mm×300 mm×3 mm (thickness).

Spraying was carried out at a rate of 11 l/h and a nozzle displacement speed of 0.45 m/s with 4 translations. A continuous film was formed on one side of the plate, which was dried for 10 minutes in air and then heated for 20 minutes at 200° C.

The glass-ceramic plates comply with the domestic electrical appliances standard NF EN-60-335-2-6.

Next, a set of plates not treated according to the invention and a set of treated plates were subjected to mechanical strength tests.

The plates were held horizontal so as to leave a 240 mm×240 mm central area free, the reinforcing coating according to the invention, when present, being on the underside.

The plates were subjected to three series of impacts from above, localized on twelve impact areas according to the NF EN 60-068-2-75 standard (Norwegian hammer). The impact energy of the instrument was 0.7 J.

The fracture rates were:
32% in the case of the untreated plates;
5.5% in the case of the coated plates.

Another set of glass-ceramic plates treated according to the invention was subjected to aging over a radiant heat source 145 mm in useful diameter, which was positioned beneath the plates at their center. The coatings of the invention, again on the underside, were heated in 450-600° C. cycles for 30 minutes and left to cool down for 30 minutes.

The same impact tests as previously were carried out on plates having been aged on radiant sources for:
18 hours: 3% fractured;
350 hours: 8.3% fractured.

It is important to note that the improvement in mechanical strength provided by the invention is maintained for the standard use—i.e. on a cooker—of the glass-ceramic plates.

1. A composition for treating the surface of a glass-ceramic, especially in plate form, or glass, in the form of fibers, said composition being able to be applied as a thin coating to said glass-ceramic or said glass, characterized in that it comprises, in aqueous medium, the following constituents (A) and (B):
(A) at least one compound having at least one functional group f_{(A)}; and
(B) at least one compound having at least one functional group f_{(B)} capable of reacting with the functional group or groups f_{(A)} of constituent (A) within the thin coating applied to the glass ceramic or the glass so as to convert said coating by polycondensation and/or curing into a solid coating;
at least one of the compounds involved in the definition of (A) and (B) having at least one R—O-functional group attached to a silicon atom, R representing an alkyl residue; and at least some of the compounds having at least one R—O-functional group attached to a silicon atom, which may be in a hydrolyzed form resulting from a prehydrolysis or a spontaneous hydrolysis that has taken place while the compound or compounds are in contact with the aqueous medium.

2. The composition as claimed in claim 1, characterized in that the alkyl residue R is a linear or branched C₁-C₈ alkyl residue.

3. The composition as claimed in either of claim 1, characterized in that the functional groups f_{(A)} and f_{(B)} may especially be chosen from —NH₂, —NH—, epoxy, vinyl, (meth)acrylate, isocyanate and alcohol functional groups.

4. The composition as claimed claim 1, characterized in that the functional groups f_{(A)} and f_{(B)} of the constituents (A) and (B), respectively, are chosen from the following families:
amine/epoxy;
amine/(meth)acrylate;
epoxy/(meth)acrylate;
(meth)acrylate/(meth)acrylate;
vinyl/(meth)acrylate;
vinyl/vinyl;
epoxy/epoxy;
isocyanate/alcohol.

5. The composition as claimed in claim 1, characterized in that constituents (A) and (B) are chosen from:
melamine, ethylenediamine and 2-(2-aminoethylamino)ethanol;
derivatives of bisphenol A;
(meth)acrylate monomers or oligomers;
compounds of formula (I):
A-Si(R¹)ₓ(OR²)₃ (I)
in which:
A is a hydrocarbon radical possessing at least one group chosen from the amino, alkylamino, dialkylamino, epoxy, acryloxy, methacryloxy, vinyl, aryl, cyano, isocyanato, ureido, thiocyanato, mercapto, sulfane or halogen groups, which is linked directly to the silicon or via an aliphatic or aromatic hydrocarbon residue;
R¹ represents an alkyl group, or A as defined above;
R² represents a C₁-C₈ alkyl group that may be substituted with an alkyl [polyethylene glycol] residue;
x=0 or 1 or

6. The composition as claimed in claim 1, characterized in that the (A)/(B) combinations are chosen from:
methacryloxypropyltrimethoxysilane/polyethylene glycol diacrylate;
methacryloxypropyltrimethoxysilane/glycidoxypropylmethyldiethoxysilane; and
3-aminopropyltriethoxysilane/glycidoxypropylmethyldiethoxysilane.

7. The composition as claimed in claim 1, characterized in that it furthermore includes:
(C1) at least one polymerization or polycondensation catalyst for constituents (A) and (B); and/or
(C2) at least one UV or thermal radical polymerization initiator or UV cationic polymerization initiator.

8. The composition as claimed in claim 7, characterized in that constituent (C1) is/or includes a tertiary amine.

9. The composition as claimed in claim 7, characterized in that the radical polymerization initiators are compounds containing benzophenone.

10. The composition as claimed in claim 1, characterized in that it furthermore includes:
(D) at least one scratch/wear protection agent chosen from waxes, fatty acid partial esters and fatty acids, and polyurethanes and other polymers known for their protective function.

11. The composition as claimed in claim 1, characterized in that it furthermore includes:
(E) at least one polymer in emulsion, the T_{g} of which is between 0 and 100° C.

12. The composition as claimed in claim 1, characterized in that it includes:
(F) at least one surfactant.

13. The composition as claimed in claim 1, characterized in that it comprises, in aqueous medium, for a total of 100 parts by weight:
up to 25 parts by weight of constituent (A);
up to 25 parts by weight of constituent (B);
0 to 25 parts by weight of constituent (C1) as defined in claim 7;
0 to 25 parts by weight of constituent (C2) as defined in claim 7;
0 to 25 parts by weight of constituent (D) as defined in claim 10;
0 to 25 parts by weight of constituent (E) as defined in claim 11; and
0 to 25 parts by weight of constituent (F) as defined in claim 12,
the aforementioned quantities being indicated as dry matter and, when an agent is introduced in the form of an aqueous solution or emulsion, the quantity of water of this solution or emulsion then forming part of the aqueous medium of the composition.

14. The composition as claimed in claim 1, characterized in that the functional groups f_{(A)} of constituent (A) are —NH₂ and/or —NH-functional groups, and the functional groups f_{(B)} of constituent (B) are epoxy functional groups, the ratio of the number of —NH-functional groups of constituent (A) to the number of epoxy functional groups is between 0.3/1 and 3/1, limits inclusive.

15. The composition as claimed in claim 1, characterized in that it has a viscosity at room temperature of between 1 and 3 centipoise using the rotating cylinder method.

16. A method of treating the glass-ceramic or glass surface in order to improve the mechanical strength thereof by healing the surface defects, characterized in that a thin film of the composition as defined in claim 1 is applied to the glass-ceramic or glass parts to be treated with a thickness that may range up to 3 microns, and in that said composition undergoes a curing or polycondensation reaction.

17. The method as claimed in claim 16, characterized in that the thin film applied is dried and then passed beneath UV lamps, the treatment lasting from a few seconds to 30 seconds.

18. The method as claimed in claim 16, characterized in that a heat curing or polycondensation operation is carried out.

19. The method as claimed in claim 16, in which the glass to be coated is a hollowware article, characterized in that the procedure is to deposit the composition by spraying it onto the hollowware after the annealing lehr, the temperature of the hollowware during spraying being between 10 and 150° C.; and
when the composition does not contain a catalyst, by making the hollowware pass through a curing oven at a temperature of 100 to 220° C. for a period of time ranging from a few seconds to 10 minutes; and
when the composition does contain a catalyst, by letting the curing reaction take place without passage through a curing oven.

20. A glass-ceramic plate, flat glass plate or hollowware article treated by a composition as defined in claim 1, using the method as defined in claim 16.

21. Glass fibers, especially optical fibers, treated by a composition as defined in claim 1 using the method as defined in claim 16.

22. The method of using a composition as defined in claim 1 for improving the mechanical strength of a glass-ceramic or a glass by healing its surface defects.
